(19) United States
(12) Patent Application Publication
(10) Pub. No.: US 2016/0155261 A1
(43) Pub. Date: Jun. 2, 2016

(54) Rendering and Lightmap Calculation Methods

(71) Applicant: Bevelity LLC, Palo Alto, CA (US)

(72) Inventor: Daniel Iborra Olba, Palo Alto, CA (US)

(21) Appl. No.: 14/950,032

(22) Filed: Nov. 24, 2015

Related U.S. Application Data
(60) Provisional application No. 62/084,795, filed on Nov. 26, 2014.

(51) Int. Cl. G06T 15/50; G06T 17/20; G06T 15/04; G06T 15/10

(52) U.S. Cl. CPC G06T 15/506; G06T 15/10; G06T 17/20; G06T 15/04

(57) ABSTRACT

A rendering method that comprises defining islands of connected triangles whose difference between normals is less than the geometries of the instances, and putting them in boxes, and in that said boxes are in turn grouped into cubes, prior to calculating the lightmaps. Said grouping may be by material and textures, and the method shall define each box inside the cube by its two end coordinates.

It likewise comprises a method for calculating lightmaps by dividing into three different textures: direct lights, ambient illumination or occlusion and sunlight, and calculating them independently.

### CROSS REFERENCE TO RELATED APPLICATIONS

This application claims the benefit of U.S. Provisional Patent Application Ser. No. 62/084,795 filed Nov. 26, 2014 entitled “Rendering and Lightmap Calculation Method”, which is incorporated by reference herein in its entirety.

### FIELD OF APPLICATION

The present invention relates to a rendering method that may be applied in real time and a lightmap calculation method that enables high quality results to be obtained in a very short processing time.

### STATE OF THE ART

In all professional areas in which 3D models are created in order to improve the production processes, it is necessary to be able to simply and quickly share and view these models with all the project members, including clients, in order to be able to analyze the state of the project or deigns and be able to thus persuade or make decisions. For this, it is essential for the model to be easily accessible, online and from devices or personal computers, and for the viewing quality be as close as possible to what the final model will be, which means representing complex materials, high-quality shadows, global illumination and ambient illumination occlusion (FIG. 3).

Currently, there are two groups of solutions to be able to view 3D models online and with realistic quality: iterative rendering and real-time rendering.

The first consists of iteratively generating the image render using the power from remote servers and transmitting the different iterations of static images and then improving the quality. The second consists of using the GPU (Graphics Processing Units) to draw several images per second, always in the same quality, in order to create a sense of animation.

3D models generated using CAD applications are for the most part made up of a multitude of small objects that are repeated (instances) whose hierarchy forms the complete model. For example, in architecture it is common for each building to be formed of floors that in turn contain rooms, which in turn contain doors and that in turn are formed of various elements. This implies that the scenes may contain a multitude of geometries (groups of polygons) repeated in different positions, as well as a multitude of lights. In architecture, for example, an average scene may contain 30,000 instances and hundreds of lights to light up the inside of the buildings. Therefore, there are many objects with different complex materials, each one being affected by thousands of lights, each one projecting shadows around it.

In all the current real-time solutions that enable photo-realistic quality, both video game engines and generic visual displays, it is assumed that 3D models have been manually optimized so that the drawing process is optimal and is able to generate a minimum of 12 images per second.

One of the bottlenecks when rendering complex scenes is the communication between the CPU (central processing unit) and the GPU, which occurs every time the material, texture of geometry is changed. When a complex scene formed of thousands of objects, with different materials, lightmaps and textures, is rendered, the main bottleneck are these calls.

The conventional method for manually optimizing 3D objects consists of grouping the different objects, in order to reduce their number to a maximum of tens or hundreds of objects, instead of tens of thousands. When a complex 3D model is imported directly from a CAD application, without prior manual optimization that reduces the thousands or tens of thousands of small objects, all the current solutions are unable to draw the model quickly enough (12 fps). Moreover, it must be noted that when the user manually optimizes the 3D model, thus reducing the number of elements, the final model that used is not the same as the original model, such that, on the one hand, the changes in the CAD model cannot be propagated into the imported model, and on the other hand, it is not possible to carry out actions such as separate or select individual parts of the model.

Another problem that currently exists is that the scene lighting needs to be pre-calculated via lightmaps in order to be able to represent the 3D scene photo-realistically and efficiently. This solution means that, on the one hand, the UV coordinates of 3D objects in the scene have to be calculated (used in the computer calculation) and, on the other hand, the pre-calculation process has to be carried out. Currently, there are solutions that enable the UV coordinates to be calculated automatically for each object or the entire scene. This poses two problems: one is that these methods are incompatible with the concept of instances since each object needs its own UV coordinate map and, therefore, it is not possible to reuse the same geometry, drawing it in different positions, and therefore new geometries must be created. The second is that the current systems either generate a single map with all the objects, which is insufficient in order to obtain the necessary quality, or generate a map for each object, which does not enable the scene to be correctly optimized. In practice, manual optimization means that the user has to decide how to group, for each scene, the different objects or portions of objects so that the final scene has, on the one hand, few objects and, on the other hand, several good quality maps.

A further complicating factor is also the pre-calculation of lights, since a long calculation process (from minutes for a very small scene to hours or days) is needed in order to obtain photo-realistic quality and for each small variation in the scene the maps must be recalculated, i.e. run the light calculation process, wait until it finishes and then see the results. This means that the process for configuring the scene lighting is long and complex. In turn, this means that the lighting may only be calculated during the pre-process and editing stage of the interactive 3D model, and not in the final viewing and thus be able to make dynamic changes in the global illumination of the scene, for example, to calculate the lighting of the model at different times of day.

It must also be noted that the pre-calculated lighting may only be used in scenes with static geometry, since as an object is animated, the lighting changes and, therefore, all the lightmaps must be recalculated.

### BRIEF DESCRIPTION OF THE INVENTION

The invention consists of a rendering method, as defined in the claims.

The focal point of the invention is on presenting 3D models completely interactively, creating a sensation of continuous movement and showing the model instantaneously, which places the focal point on real-time rendering, on which the solution is based.

The main technical factors that determine the drawing speed of the scenes are:
Number of CPU-GPU calls (draw calls).
Change of textures.
Number of polygons in the scene.
Size of textures.

An object of the invention is to enable scenes imported directly from CAD programs to be rendered in real time with photo-realistic quality without requiring manual optimization and also maintaining the original elements of the 3D model.

Being able to automatically and efficiently calculate the UV coordinates of the scene taking into account the instances of the scene, optimizing the object groups taking into account the rendering speed and maintaining the original number of geometries of the scene is also an object of the invention.

Generating lightmaps automatically and iteratively, such that the lighting effects of the scene may be modified and the result may be seen in real time, similarly to the concept of iterative rendering but applied to lightmaps, is equally an object of the invention. Furthermore, this solution makes use of conventional GPUs and, therefore, may be used in devices or personal computers, which is one of the main requirements.

The solution enables static objects to be present in the same scene as animated objects whilst maintaining high-quality graphics.

The invention proposes a novel and completely automatic method for pre-calculating the global illumination of a complex 3D model, automatically optimizing and viewing it in real-time on computers and devices via the use of its GPU and also using servers via streaming or GPU clusters.

The drawing system is based on automatically reducing the number of polygons and the size of the textures in the scene and the number of GPU calls (draw calls) that occur when drawing objects or different materials. When a scene formed of single geometries and instances that they refer to is loaded, the instances are grouped according to their material and for each group a new geometry is calculated, linking and transforming each geometry into a common coordinate system, in such a way that the drawing of several instances is subsequently substituted by the drawing of a single object in a single material and, therefore, requires a single draw call. Unlike the state of the art in which the instances have to be converted into a common geometry that must be kept as such, and after calculating the lightmaps, this novel process enables lightmaps to be calculated whilst maintaining the original instances and geometries independent. Also unlike the state of the art, this process enables the calculation of how many lightmaps have be generated and what instances they must contain in order to optimize the subsequent drawing speed, and all carried out automatically.

In order to group a group of instances they do not only need to all have the same material but share the same lightmap. The system enables lightmaps to be generated automatically for each group almost without increasing the size of the scene geometry or its loading time.

The aim of drawing the 3D model with photo-realistic quality implies that the UV coordinates of the scene are calculated automatically and its content is subsequently calculated. It is based on the calculation method for angle-based UV coordinates (as described by A. Sheffer et al en “Parameterization of Faceted Surfaces for Meshing using Angle-Based Flattening” (Engineering with Computers; October 2001, Volume 17, Issue 3, pp 326-337) and in “ABF++: fast and robust angle based flattening” (ACM Transactions on Graphics (TOG); Volume 24 Number 2, April 2005; pp 311-330)) in which the geometry is split into independent groups of connected triangles and with similar angles, which are subsequently ordered to make up a UV map in 2 dimensions.

The calculation methods for angle-based UV coordinates may be divided into four steps:

1 Design the geometry to create islands of connected triangles, grouping those that have a low difference between their normals (from 45 or 66°).

2 Assign a box to each island that represents the limits of its triangles.

3 Place the boxes in an ordered manner to minimize the size of the set of boxes.

4 Reposition the triangles of each island on the final coordinates of their respective boxes.

Once the UV coordinates of a geometry have been calculated, this method enables the set of instances to be taken and the 3 previous steps to be applied in order to calculate the final position of the instance in the lightmap independently of the UV coordinates of its geometry.

In the recommended system, the UV coordinates of each geometry is calculated independently, thus obtaining a UV coordinate system in the space [0 . . . 1] (i.e. with coordinates between 0 and 1 on each axle, which is known as normalization). A lightmap is generated for each material of the model in which the instances of the geometries of this material are grouped together.

In order to calculate the UV space of each instance, each instance is considered to be a 2D square, the size of which is relative to the size of the instance in world coordinates (i.e. 3D), so that the quality of the lightmap corresponds to the size of the instance, and the box sorting algorithm, which is explained below, is applied but this time on the 2D squares that represent the instances. The 2D coordinates of these squares are subsequently assigned to their respective instances. In order to calculate the final coordinates of each instance, the original UV lightmap of the geometry simply has to be designed in the common space of the lightmap using the previously calculated start and end coordinates (FIGS. 1 and 4).

The solution also includes the iterative calculation of lightmaps in order to drastically optimize the configuration process by the user. Once the UV coordinates have been created, its content is calculated rendering each light directly in the UV space of each lightmap via cumulative texture and using the GPU. For each light, whether direct light or ambient or global illumination, the process is divided into different consecutive stages that are differentiated depending on the type of light. Given that each stage is the equivalent to a GPU render and these are executed very quickly, the different stages may be calculated and the results iteratively shown to the user from the first stage.

The solution also includes the automatic simplification of the scene textures, as well as the simplification of the geometry without deteriorating the level of detail perceived. In the majority of 3D scenes generated by CAD programs, the high number of polygons is concentrated on curved surfaces, since straight surfaces may be accurately modeled with a low number of polygons. The solution is supported by the aforementioned calculation for angle-based UV coordinates to divide the geometry into adjacent areas that have a nearby angle. Each grouping is triangulated using the perimeter thereof as if it were a 2D polygon, which discards the inner triangles but maintains the outer perimeter. The normal map is subsequently calculated using the original geometry, which is used in the drawing in order to simulate the detail of the original geometry but using a mesh with fewer polygons. The recommended solution also includes an improvement in the perimeter simplification of the groups in order to simplify more aggressively. Two edges of the perimeter are selected for each group whose angles are close to 180° and in such a way that both are shared by another and only on other group, and they are joined together. The process is repeated until no more edges can be selected in order to subsequently continue the process of consistent triangular optimization and calculate the normal map.

With regards to the textures, there is an algorithm that enables the loading of textures to the memory of the device to be adjusted whilst maintaining the maximum quality perceived by the user. In order to do so, the images are divided depending on their function: texture, normal map, lightmap, UI image. The algorithm automatically selects the quality of each texture so that the scene does not exceed the limits of the device or PC's memory. When a 3D scene is loaded, most of the memory is divided between the geometry and the textures, and on average the memory required for textures is 5 to 10 times greater than the memory required for the geometry, hence the importance of optimizing the textures (FIG. 5).

### DESCRIPTION OF THE DRAWINGS

For a better understanding of the invention, the following figures have been included:

FIG. 1: is a schematic and illustrative example of the islands inserted into boxes inside a cube.

FIG. 2: is a schematic view of the different rays in a specular image.

FIG. 3: images taken from 3 realtime 3d interactive scenes (60 frames per second)

FIG. 4: precalculated lightmaps of two realtime scenes (rendering of the lightmaps took 10.43 s for the car and 8.21 s for the house).

FIG. 5: these 3 images show 3 different texture qualities: normal, medium and low.

FIG. 6: on the left, the lightmaps created for each material (1 m 49 s to render all the maps). On the right, the final render.

FIG. 7: lightmaps calculated with different qualities (specifying the total memory of the lightmaps): 16 MB (2 m 25 s), 32 MB (3 m 15 s), 128 MB (6 m 53 s).

FIG. 8: lightmaps calculated with different number of rendering passes: 16, 128, 1024

FIG. 9: the light passes through translucent materials.

FIG. 10: lightmaps calculated using the skybox (top) and without using it (bottom).

FIG. 11: visual artifacts (left) are removed when rendering with antialiasing (right).

### EMBODIMENTS OF THE INVENTION

What follows is a brief description of an embodiment of the invention by way of illustrative and non-limiting examples thereof.

As mentioned above, the main technical factors that determine the drawing speed of the scenes are:
Number of CPU-GPU calls (draw calls).
Change of textures.
Number of polygons in the scene.
Size of textures.

Therefore, these numbers must be reduced and for which reason the process is as follows:

In order to reduce the number of draw calls and the change of textures, the objects of the scene are drawn grouped together by material and texture. When a scene formed of single geometries and the instances that they refer to is loaded, the instances are grouped according to their material and a new geometry is calculated for each group, joining and transforming each geometry into a common coordinate system, in such a way that the drawing of several instances is subsequently substituted by the drawing of a single object in a single material and, therefore, requires a single draw call. In the case that a geometry is formed of several materials, it is subdivided into several fragments that will be grouped together (FIG. 6).

Given that the coordinate system of a group has to be common, only the nodes that are static with respect to each other may be grouped together, either because they are static in relation to the world coordinates or because they share the same parent node, which will be the one that is animated.

To be able to group several objects, it is important that they not only have the same material and, therefore, the same texture, but that they also have the same lightmap. This means that the instances should first be grouped when the lightmaps are generated and this same group should be used in the drawing. Therefore, all the subsequent optimizing factors must be taken into account during the grouping, since once the objects have been grouped they may not be subsequently ungrouped.

To be able to draw the scene with photo-realistic lighting, the groups of geometries are calculated in order to define the lightmaps that will be used, the UV coordinate systems are generated and the content of the lightmaps is pre-calculated, following a completely automatic process. An angle-based UV coordinate calculation method is applied, with the four steps noted above.
1) Project the geometry to create islands of connected triangles and that have a low difference between their normals.
2) Assign a box to each island that represents the limits of the triangles thereof.
3) Place the boxes in an ordered manner to minimize the size of the set of boxes.
4) Reposition the triangles of each island on the final coordinates of the respective boxes thereof.

This method enables the coordinates of a geometry to be calculated in a space [0 . . . 1] and may be extended to a set of instances, taking all the islands designed independently of each instance and applying the previous second step to the entire set.

In the solution described the UV coordinates [0 . . . 1] of each geometry is first calculated independently, instead of grouping all the instances and calculating a common map. Subsequently, a lightmap for each material of the scene is calculated and the instances whose geometries have this material are assigned to it. In the case that the geometry is formed of several materials, the geometry is divided into fragments depending on its material and these new fragments are grouped in the corresponding lightmap thereof. The following step is to calculate the UV space for each lightmap, considering each instance to be a box and applying point 3 of the above method. The reason for dividing the lightmaps by material is to optimize the drawing speed.

The size of each box in the lightmap determines the viewing quality of the object when it is drawn on the screen. Since one aim of the invention is to obtain a uniform quality throughout the scene regardless of the size of the objects or the number thereof, the size of each box is linked to the size of the 3D geometry of this instance in world coordinates. In this way, the size of the pixels is kept the same in the space of world coordinates. Furthermore, in order to improve this approximation, not only will the size of the instance have to be taken into account but also the detail of the object via the number of vertices of the geometry and the number of islands of the individual coordinate map thereof:

B=\sqrt{(Bx)²+(By)²+(Bz)²}

S=Ka·B+Kb·V+Kc·I

S: size XY of the instance in world coordinates.

B: volume of the box or bounding box of the instance, with dimensions (Bx, By, Bz).

V: number of vertices of the geometry of the instance.

I: number of islands on the coordinate map of the geometry of the instance.

Ka, Kb, Kc: constants that may be configured by the user in order to improve the approximation of the instance quality.

For each lightmap, its list of boxes is obtained and the aforementioned method for sorting boxes in a cube, which covers all the others, is applied to them. For each instance this method will give two coordinates within the cube, the start coordinate (P1), or the closest to the point of reference, and the end coordinate (P2), or the furthest from the point of reference. Given that each geometry has its own space of normalized UV coordinates [0 . . . 1], the coordinates of the geometry are projected on the lightmap coordinates using the points P1 and P2 in each dimension (x, y, z) in order to calculate the coordinates of each instance.

UVfinal=P1+UVgeometry·(P2−P1)

While in previous methods it was necessary to calculate an additional UV coordinate map for each instance of geometry, with this new method each geometry has a single UV coordinate map and only two 2D coordinates are saved for each instance.

Using as an example a scene with 1,000 repeated instances, where the average number of vertices per geometry is 100, the minimum number of 2D coordinates that are saved using the previous methods is 1,000×100=100,000, while with the new method it is 1,000×2=2,000, which is 50 times less.

Firstly, this enables the scenes to be loaded and the geometry to be saved more quickly, since the changes in the scene do not affect the model once a geometry has been calculated. Secondly, it enables the speed of the coordinate calculation to be improved, since as the calculation algorithm is not lineal but exponential, it is much quicker to sort the boxes of the instances, ignoring the islands thereof, than joining together all the boxes of the inner islands of each instance in a same scene and sort the set.

Likewise, it enables the number of lightmaps that need to be created to be calculated, one per set of material and texture and one more per each dynamic node.

Moreover, for each modification in an instance, whether it be its position or size or the deletion or copy thereof, only the two coordinates P1 and P2 of the instances have to be recalculated. The enables the scene editing process to be sped up both when calculating and saving, especially in online editing environments.

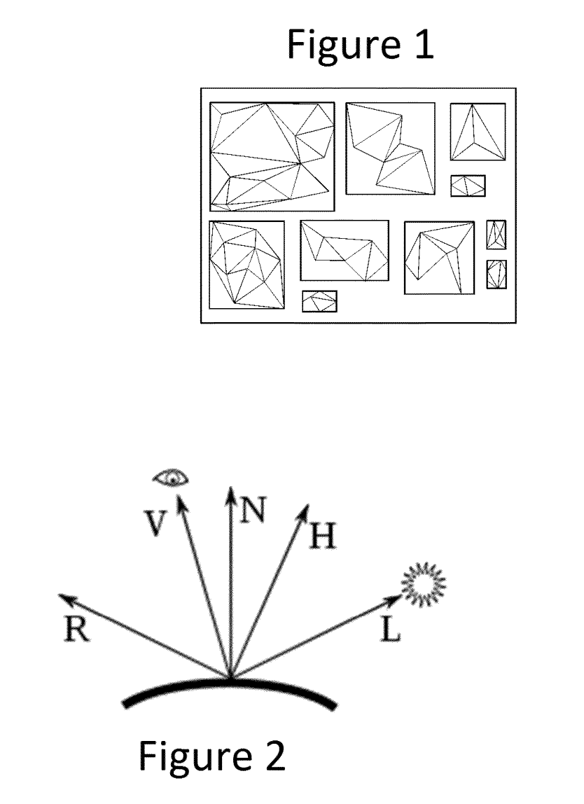

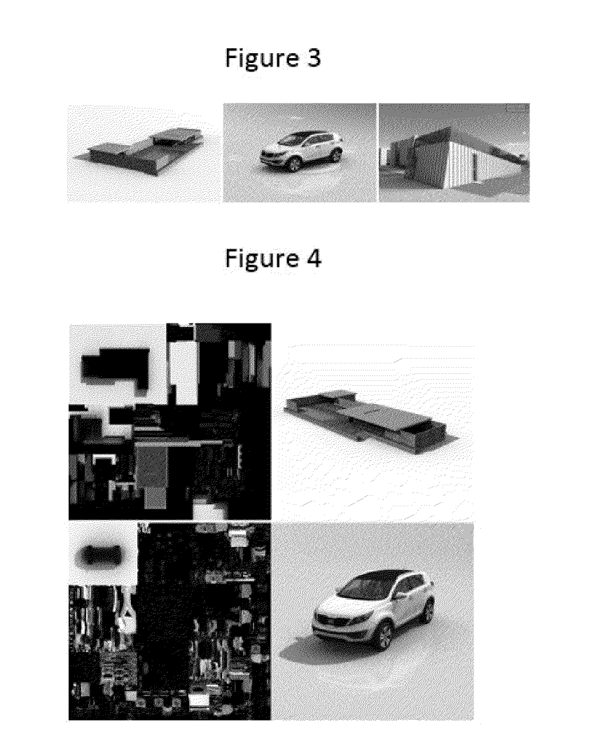

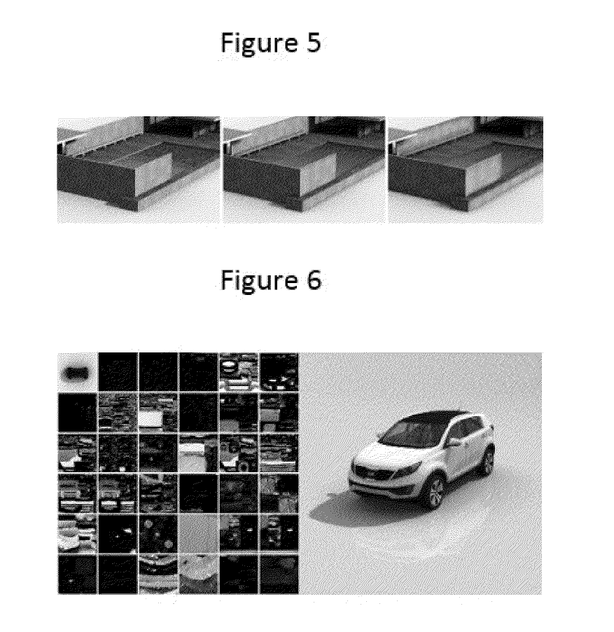

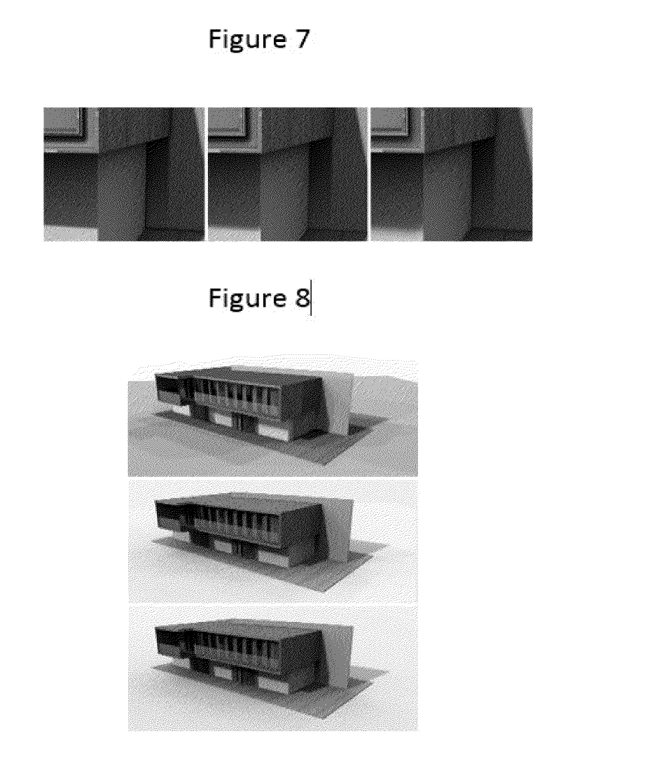

In the process of sorting the boxes in the cube (FIG. 1), whether in the process for each geometry or globally, it is important to take into account the distance parameter between boxes so that when an object is being drawn using a lightmap there is no pixel superposition of other objects within the limits of the areas. In order for this distance to be effective, it is important that the distance between boxes be relative to the size of the coordinates map.

In the previous solutions, the distance may only be established as an absolute value, which may be a greater or lesser relative value depending on the size of the coordinates map before being normalized to [0 . . . 1]. In other words, the same separation value will result in a completely separation space depending on the coordinates map. Thus, a separation value of 5 units will be greater when the map has a maximum dimension of 1,000 than if the maximum dimension is 100,000.

This means that in the current systems, the user has to manually configure the value of each map through trial and error since the modification itself of the value generates a new map with different measurements, which in turn causes another change in the final relative value of the space. The solution described in this document to automate this calculation consists of approximating the value of the distance by first calculating the size of the map before normalizing.

When the boxes in the cube are sorted, the biggest boxes are placed first followed by the smaller boxes. The bigger boxes configure the space while the small ones are placed between the spaces of the bigger boxes. This implies that the biggest boxes are the ones that really configure the space and the small ones adapt to this space that already exists. Therefore, the number of spaces may be approximated with the number of bigger pieces, applying the square root to it since the final configuration in in two dimensions.

As fixing the distance between the boxes is desired, the total size of the boxes (which is the cube without spaces) may be divided by the approximate value of the number of spaces (the square root of the number of boxes) and multiplied by the percentage of space use that is desired in order to obtain an absolute separation value between boxes. In the method of the invention, the number of spaces is estimated using only the biggest boxes:

$$D = \frac{P \cdot max ( W , H )}{2 \cdot max ( 1 , \frac{\sqrt{N}}{C} )}$$

D=distance between the boxes of the map.

P=percentage of space that is to be dedicated to the separation between boxes (for example, 5%).

N=number of boxes that are bigger than a global percentage (normally 25%) of the maximum size of boxes.

W, H=width and height of the map or cube size without any distance between the boxes.

C=constant of the minimum number of boxes, which is normally 10.

An improvement of the box sorting method, which enables the process speed to be improved, is also presented. In the original method, every time a box is inserted into a cube all the free vertices of the box have to be sorted depending on the maximum distance to the start point of the map or origin, in order to place the next box whilst at the same time attempting to keep the new box from increasing, or preventing the minimum of the cube from increasing.

max(Vx+Bx,Vy+By)

Vx, Vy=position of the free vertex used.

Bx, By=dimensions of the box.

In the improvement, this calculation is approximated ignoring the size of the box that is to be placed when sorting the vertices. Since the position of the vertices is fixed, if the new, free vertices sorted on the list are inserted, the final size does not need to be recalculated for each vertices every time a new box is inserted.

This approximation reduces the complexity of the previous algorithm (n²·log(n)), in order to obtain a complexity n·(log(n). If the size of the map obtained from applying both algorithms is compared, it may be seen that the difference between both is on average around 15%. Therefore, this approximation may be used when calculating the distance between boxes, thus obtaining very similar results.

Furthermore, both algorithms may be combined in order to improve the speed without affecting the quality of the result. In both methods, the boxes are inserted sorted by their size from biggest to smallest. The new method consists of using the original method until the size of the boxes is 25% of the maximum size (25th percentile), the moment in which the free vertices are sorted depending on the optimized factor and boxes continue to be inserted using the optimized algorithm. When the boxes are small:

max(Vx+Bx,Vy+By)˜max(Vx,Vy)

Therefore, the smaller the size, the smaller the error of optimization. Furthermore, the small boxes tend to be placed in the empty spaces, such that when this combined algorithm is applied, almost equal results are obtained.

One of the angle projection problems that the algorithm is that the projection may create less than optimal islands, i.e. the boxes of which have a much greater dimension than the real area of the triangles that form the islands. The quality of an island is defined as the area of the triangles of the island relative to the size of its box:

$$Q = \frac{{\sum }_{i = 0}^{n} A i}{Sx * Sy}$$

Ai=area of the triangle i of the island

Sx, Sy=dimensions of the box

Since the area of the triangles will always be smaller than its box, the value Q will always be between 0 and 1, the quality being greater the closer it is to 1. The aim is to obtain the highest quality coordinate map. The total quality of the map is the summation for all the boxes.

Therefore, in order to optimize the quality of the coordinate map, the individual quality of each islands must be brought closer to 1. The solution created for this problem consists of breaking the low-quality islands into smaller islands, the quality of which is higher than that of the original island when added up. The axis of division is defined as a centered imaginary line in the center of the box of the island, the gradient of which has an angle α. Given this axis, splitting an island consists of:

1—Selecting the vertices that are found on one side of the line.

2—Creating a list with the triangles that contain at least one selected vertex and an island is created with them:

$$V = {{⋃}_{n = 1}}^{m} {V}_{n} \text{:} ( ( {V}_{n} - C ) \cdot ( cos α , sin α ) > 0 )$$

$$I = {{⋃}_{n = 1}}^{m} T n \text{:} ( V ∈ T n )$$

C=center of the axis
α=angle of the axis
V=set of vertices on one side of the axis
I=triangular islands
Tn=triangle n

3—The remaining triangles will form the other island. Therefore, these polygons are fully contained on the other side of the imaginary axis.

In order to optimally split the island, the split is simulated according to all possible division axes and the one that results in the greatest total quality is selected. If, on splitting an island, the islands thereof do not have sufficient quality, the low-quality islands are recursively split again, with the new axis centered in the new box. The number of possible axes for each box is a number that may be programmed by the user (Ne), such that the angle increase between splits will be Δα=π/Ne (radians).

Moreover, the maximum recursion depth must be monitored, i.e. the number of divisions that may be applied to the island and to its recursively divided islands due to not having a quality that is greater than or equal to that which is desired (in architecture, for example, the desired quality may be 80%, whilst the maximum depth is 3). The described algorithm is applied to each island of the map that has a quality lower than the quality desired and new islands are inserted as new individual islands of the map, the new set of islands thus substituting the original island. The subdivision is carried out a maximum number of times, which will generally be 3.

In order to group various nodes in a single geometry that may be drawn in one go, all the nodes need to share the same coordinate system and their position relative to this coordinate system must not change. When the instances are joined to form the same geometry, the geometries of these instances have to be changed to the reference coordinate system:

$$U = {{⋃}_{n = 1}}^{m} ( {T}^{- 1} \cdot Wn \cdot {G}_{n} )$$

U=geometry that results from joining the instances.

Wn=transformation matrix of the instance n in world coordinates.

T=transformation matrix of the resulting geometry in world coordinates.

Gn=geometry of the instance n.

In order to draw new geometries in world coordinates, the geometry is multiplied by the transformation matrix T:

Gw=T·U

And if both formulas are joined together it gives:

$$G w = T \cdot ⋃ = T \cdot {{⋃}_{n = 1}}^{m} ( {T}^{- 1} \cdot Wn \cdot {G}_{n} ) = {{⋃}_{n = 1}}^{m} ( T \cdot {T}^{- 1} \cdot Wn \cdot {G}_{n} ) = {{⋃}_{n = 1}}^{m} ( W n \cdot {G}_{n} )$$

In other words, if the nodes are static with respect to the common reference system, creating the new geometry by joining all the nodes transformed into local coordinates to the common reference system and animating this system is the same as maintaining the non-grouped nodes and animating their transformation. This enables groups to be generated whilst maintaining the possibility of animating nodes. In order to do so, the nodes that are to be animated must be known a priori and the groups must be made taking this into account.

The grouping system for materials will be extended for animated scenes, taking into account the animated nodes.

Given an animated node, all its non-animated child nodes are grouped and divided by material, thus creating one unique lightmap per division. Therefore, each map will have a unique material assigned to it, and will group together all the static child nodes of this material. A thorough search is subsequently carried out among the child nodes of the animated node and the same recursive grouping process is applied when the animated child node is found.

The process begins by considering the root node of the scene to be an animated node, and the grouping process by materials is applied to it. A list of lightmaps, which group all the instances of the scene sorted by material, is obtained when there are no more dynamic nodes to process. This list of maps is optimal from the viewpoint of the drawing speed while enabling the nodes to be animated.

Before grouping the nodes it must be known which nodes will be animated and which will not. In order to do so, all the animations that affect the scene must be processed and the nodes that are modified in any of the animations “marked” as dynamic. The user will also be able to mark any node as dynamic, so that it may subsequently be moved through programming.

The maps need to be recalculated when the mark of a node is modified. It is for this reason that the optimization solutions presented are important in order to be able to quickly recalculate the lightmaps and groups when there is any change in the animations.

Although the joined geometries must have the same material and attributes, it is possible to apply different attributes to each independent geometry that may be used in some cases. When the vertices are generated from the new geometry, an attribute is added to the vertices and a different value may be assigned to it per node. For example, an index may be added to each vertex or a coordinate of N dimensions, the value of which will depend on the node to which the vertex belongs. Therefore, when the geometry is drawn, this attribute may be used to draw the vertices of each node differently.

One example of use is assigning a position of a texture to each vertex according to its node, which makes it possible to apply different effects, such as painting each node in different colors. The position of the texture may also be assigned according to the position of each vertex and to interpret the texture as a map, thereby making it possible to transfer the colors on the map to the geometry. Another use constitutes assigning vertices, according to their node, with an in index to a list of transformation matrices, which may be used to draw the geometry in one go, in order to facilitate animations. In this case, rather than animating the nodes independently, they are joined together and a different index is assigned to their vertices, a list of transformation matrices that may be animated being created and the joint object being drawn in one go, transforming each vertex with the matrix selected according to its index.

The way in which objects are grouped together may optionally be modified, by dividing the scene into areas. The aim is to be able to hide parts of the scene according to the position of the camera, for example when it comes to drawing cities. Once the way in which the space will be divided has been chosen, for example using a 2D grid in the case of cities, when the objects are grouped, each node is assigned to an area. Once all of the nodes have been classified, the objects in each area are grouped following the process explained above. Although this modification creates more objects, given that the same are sorted by areas, it becomes more likely that when part of the scene is viewed, everything that cannot be seen is discarded, which improves drawing speed.

In order to maintain the visual coherence of the quality of the lightmaps in relation to the size of the objects, it is important to automatically calculate the size of each lightmap in pixels.

$$R i = D \cdot \frac{S i}{\frac{1}{n} \cdot {\sum }_{i = 0}^{n} S n}$$

Ri: resolution of the lightmap i.
Si: size of the UV coordinates map i.
Sn: size of the UV coordinates map n.
D: default dimensions of the texture.

The dimensions of each lightmap are calculated by dividing the size of the lightmap by the average size of all the lightmaps, then multiplying this factor by the default dimensions of the lightmaps assigned by the user. The largest maps will therefore have dimensions above average, whilst the smaller maps will have dimensions below average. The default dimensions of the lightmap may be configured comprehensively by the user, in order to reduce or improve the overall quality of the scene.

Another way of calculating resolution consists in specifying the pixel quality for the actual size of the scene.

Ri=Q·Si

Q: quality factor

A third way of calculating the resolutions consists in specifying the maximum memory size dedicated to lightmaps and automatically calculating the quality factor described above.

$$R i = M \cdot \frac{S i}{{\sum }_{i = 0}^{n} A i}$$

M: Total amount of memory wanted to be used

An: Area of the UV coordinates map n, obtained by multiplying its width by its height

An attribute may be added to each coordinates map, which enables the user to modify the quality of each map. This attribute is a multiplication factor of the dimensions of the map, where its defect value is 1.0 but may be increased or decreased in order to create the lightmap as though it were larger or smaller in size.

Grouping the geometries into boxes and the same into cubes presents two potential problems: one is that too many geometries are grouped, which results in the separation between geometries being too low for the distance implemented to avoid pixel collision when rounding errors arise and the other is that the grouped geometry might have too many polygons for the system (webgl, opengl, directx) or to be drawn efficiently (visibility culling). The solution proposed consists in dividing the map into various smaller maps and distributing the geometries.

The first factor to bear in mind is limiting the number of polygons or triangles in the geometry in each cube, since, depending on the operating system or GPU, it is not possible to use indices of over 16 bits, which means it is not possible to draw geometries with more than 65535 different vertices. The invention proposes creating a maximum limit (K), which may be programmed or detected by the software applying the process, on the number of vertices in each cube, which will gradually be filled with instances, which may mean making more cubes than theoretically necessary available (one per material and texture). In order to do so:
[a]. The instances are ordered from more to fewer vertices
[b]. A first cube is created and the first instance is added to it
[c]. The next instance is selected
[d]. The cubes are passed over in order until one in which the total number of vertices will not exceed the limit K if the instance is added to it is found
[e]. If no free cube is found, a new cube is created and the instance is added to it
[f]. This process is repeated for each instance until there are no more instances to be added

The problem of the high number of geometries may be solved by increasing the resolution of the lightmap, using a minimum number of pixels' worth of distance between boxes defined by the user and the actual distance of the boxes, with which the lightmap was calculated:

F=max(1,P/D)

P: minimum number of pixels' worth of separation between boxes.

F: multiplication factor of the lightmap resolution.

D: number of pixels' worth of separation between boxes in the lightmap.

In order to calculate the content of a lightmap, a texture is created in order to accumulate all of the calculations using the GPU, which will eventually have the end size of the lightmap.

The lightmap will be divided into 3 different textures: direct lights, ambient illumination or occlusion and sunlight. This difference is established for various reasons:

The textures may be saved and loaded with varying degrees of quality, different image formats and different degrees of compression. Sunlight will be saved at just one value of 8 bits, which will make it possible to improve the resolution, whilst using the same amount of memory. In contrast, the other two textures will be saved at 24 bits.

Sunlight and direct lights may be recalculated independently, without having to recalculate the other two textures. This makes it possible to change the sun's direction and recalculate the lighting in the scene quickly.

The sun lightmap contains the percentage of incidence of the sun for each pixel, where 0 indicates complete shade and 1 indicates complete incidence of the sun.

Static shade may be mixed with dynamic shade in real time, generated by the dynamic objects. In order to do so, a shadow map is created, in which the dynamic objects of the scene are drawn in relation to the direction of the sun. In order to draw a static object, the percentage of shade is firstly calculated using the dynamic shadow map and this value is then multiplied by the pre-calculated lightmap of the sun. The result of the multiplication is then multiplied by the result of the sun's lighting equation.

$$R = I s * I d * F ( S , P ) + {\sum }_{i = 0}^{n} F ( Li , P )$$

R: total lighting of the pixel.
F: general lighting function.
Li: direct light.
S: sunlight.
P: position of the object.
Is: static incidence of the sun.
Id: dynamic incidence of the sun.

Although textures are saved at 8 bits per pixel, upon adding the 3 maps in the drawing together, it is possible to obtain values of over 8 bits, which, when drawing on screen, will make it possible to apply glow effects or any other effects that make use of the range of values greater than 1.0, which would result in 225 using 8 bit textures.

During the process of calculating lights, it is also possible to combine the three maps into just one, thereby producing a 24 bit, 48 bit or 32 bit image by simulating a greater range.

The user may decide whether to calculate ambient light or ambient occlusion. The ambient light will contain the color of the sum of the light from the sky and the incident bounced light, whilst the ambient occlusion will be the intensity coefficient of the total incident light. Although ambient light gives a more reliable representation of reality, ambient occlusion makes it possible:
To make a good approximation when the coefficient is multiplied by the color of the sky, to which the normal of the surface points.
To combine it with maps of normals. When the color of the sky is calculated, the map of normals is used, which makes it possible to improve the detail of the texture when it comes to drawing.
To make dynamic modifications in the sky, without having to recalculate the ambient light.
To animate the node.

Given that the lightmap pertains to a node and that we know a priori whether or not the nodes are dynamic, ambient light is selected by default if the node is static and ambient occlusion is selected by default if the node is dynamic.

Solar light and direct light maps are calculated in a similar, equally innovative way:
i) A texture is created (for example a floating RGBA texture of 32 or 64 bits per channel).
ii) Each light is broken down into different, simpler passes, according to the type of light:
   Focal point: just one lighting pass is carried out. A camera with perspective similar to the focal point is used.
   Directional: just like the focus point, however using an orthogonal camera in order to simulate parallel rays.
   Punctual light: the light is divided into 6 90° pyramid shaped focal points, with 6 different directions, such that it covers the entire space.
iii) The lighting passes are accumulated in the cumulative texture:
   A lighting pass is defined by a point P in the 3D space, in addition to a direction D. The shadow map will thereby be created by rendering the entire scene from a camera centered at P, looking towards D.
   All of the objects are drawn by projecting them onto the lightmap. In order to project the vertices, rather than using the generic formula for transforming vertices

P=Pt·Vt·Wt·V

P: 2D coordinates obtained by projecting the vertices with the transformation matrices.
Pt: projection matrix.
Vt: viewpoint matrix.
Wt: world matrix.
V: 3D coordinate of the vertex.
The UV coordinates of the vertex are used directly, owing to the fact that each normalized box has been saved, by means of its end coordinates (P1, P2)

P=2·(UV−(0.5,0.5))

The light diffuses and the shadows are calculated in the standard way, using position and 3D normal of the vertex.
The pixels are drawn in addition mode, such that their value is accumulated in the cumulative texture.
The lighting pass may also be divided into two stages, by drawing the light in an intermediate texture in normal mode, then subsequently adding it to the cumulative texture.
The cumulative texture may be used directly as a lightmap or a copy of the texture may alternatively be generated in a different format, usually at 8 bits per pixel (FIG. 8).
The ambient light is calculated in a more complex way.
(1) The light from the sky is simulated as a set of directional lights, which illuminate the entire scene from all directions, taking the color of the sky in that direction in order to simulate the color of the directional light.
(2) The ambient illumination of a point is calculated as:

$$L = K \cdot \frac{π}{2} {\sum }_{i = 0}^{n} C i \cdot max ( 0 , N \cdot D i )$$

L: ambient light of a point.
N: normal of the point.
Di: direction of the ray of light.
Ci: color of the sky in the direction Di.
K: intensity multiplier, which may be configured by the user.
(3) The sky is divided into N equidistant directions and for each one, a directional lighting pass is created, which is located in the center of the model and which encompasses the entire model.
(4) All of the passes are accumulated in the texture and the result is finally multiplied by π/n and by K.

In order to calculate the ambient occlusion map, the calculation described in the ambient light process is carried out, however, assigning a 100% white color to the sky.

The end result of each map is calculated by adding the different lighting passes:

$$L M = {\sum }_{i = 0}^{n} P i$$

The lighting passes calculation may be extended to scenes containing translucent objects. The aim is to calculate the amount of light that would reach the opaque object after passing through all of the translucent objects and using this value on the lightmap, rather than using the color of the original light. It is possible to approximate the calculation for the amount of light by multiplying the color of the light by the color of the objects, bearing their opacity in mind:

$$L = L c \cdot {\prod }_{k = 1}^{n} ( 1 - {A}_{k} ) + {A}_{k} {C}_{k}$$

L: light reaching the opaque object.

Aₖ: alpha coefficient that defines the opacity of the object, 1 completely opaque, 0 transparent.

Cₖ: color of the object that will filter the light.

L_{c}: color of the light.

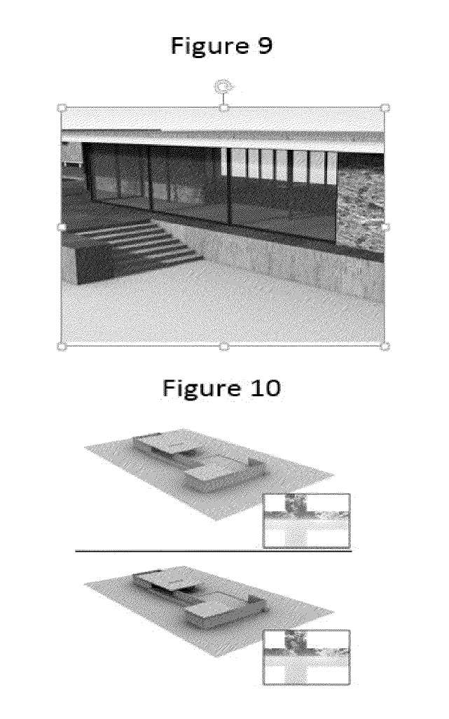

The Aₖ coefficient is enough to be able to approximate translucent objects with simple materials. For more complex materials, such as those of a Fresnel reflection coefficient, the amount of light that passes through the object depends on the angle of incidence of the light. In these cases, the Aₖ coefficient is calculated using the original shading formula, which is used to render the material on screen, which will create an effect very similar to caustic curves, in addition to making it possible to use textures with transparencies (FIG. 9).

The previous process for calculating lighting passes is modified by adding the new step of calculating the color of the incident light filtered by the translucent objects and this color is used when it comes to drawing the lightmap:
i) The depth map is calculated by rendering the objects, considering them to be opaque from the viewpoint of the light.
ii) The translucent objects in the scene are once again rendered in a separate texture, also from the viewpoint of the light, using the z-buffer of the previous render. The texture is firstly applied in the color white, then the translucent objects are drawn in multiplication mode.
iii) The objects are rendered on the lightmap by multiplying the lighting calculated on the lightmap of the pixel by the color of the texture calculated at point ii), using the same UV coordinate that was used to project the 3D point onto the shadow map.

This method makes it possible to calculate the light that reaches the opaque objects by passing through the translucent objects. The previous algorithm is modified in order to calculate the light reaching each translucent object as well:
i) The texture in which the color of the light filtered through the translucent objects will be calculated is created, which shall be referred to as “color11”. It will begin in the color white.
ii) The “depth_end” texture in which the depth map of the opaque objects is rendered is created from the viewpoint of the light.
iii) A texture is created in order to reject the surfaces for which the ray has already been calculated, which will be referred to as “mask11” and will be initialized with the minimum depth value.
iv) The texture “mask12” in which the depth map of the translucent objects is rendered is created, from the viewpoint of the light, drawing these objects as opaque, rejecting the pixels with a distance less than or equal to “mask11”; The distance of the translucent pixels closest to “mask11” is therefore obtained.
v) The translucent objects are once again rendered in a separate texture, “color 12”, rejecting the pixels with a distance not equal to mask 21.
vi) The translucent objects are rendered on the lightmap by multiplying the lighting calculated on the lightmap of the pixel by the color of the texture color11, using the same UV coordinate as the one used to project the 3D point onto the shadow map, rejecting all those pixels with a distance not equal to mask21.
vii) The texture “color12” is drawn on top of the texture “color11” by multiplying it.
viii) If the value of all of the mask21 pixels is equal to “depth_end”, the process therefore comes to an end. If not, the texture mask11 is substituted by the texture mask21 and point iv) is returned to.

The method presented makes it possible to calculate direct light coming from both direct lights and the light from the sky. In order to improve the quality of the lightmap, indirect light is added to the process. In other words, the bounces of the light on the objects, which in turn illuminate other objects, is simulated. The invention process consists in firstly calculating the lightmaps of the scene using direct light, then subsequently using the scene itself to illuminate itself. In order to calculate indirect light, a modification of the method for calculating light from the sky with translucent objects is employed, in which a multitude of lighting passes are carried out on the scene, from a multitude of directions, multiplying the color of the sky by the projection of the translucent objects through a texture (FIG. 10).

The process specifically consists in:
i) Calculating the lightmaps of the scene with direct light.
ii) Generating a copy of the lightmaps, starting at 0.
iii) The space is divided into N equidistant directions. For each direction D, all of the rays in the scene that bounce in said direction, which are accumulated on the new lightmaps, are calculated, using the lighting passes system. This micro-process consists in:
   (1) Creating a texture to reject the surfaces for which the ray has already been calculated, which shall be referred to as “mask21”, starting with the minimum depth value.
   (2) Creating another texture that will contain the light to be projected from one surface to another, which shall be referred to as “color21”, starting with the color black.
   (3) The scene is drawn from the viewpoint of the light and the depth is calculated in a new texture, mask22, previously initiated with the maximum depth value. Whilst drawing, the texture mask21 is used to reject the pixels with a real depth less than that of mask 21, relative to D
   (4) If all of the mask22 pixels have the maximum depth value, end the path, since this means that all of the pixels were rejected and that there are therefore no more surfaces upon which to project.
   (5) A lighting pass is made, in which the incidence of the light projected on the rest of the surfaces is calculated. This is then added to the lightmap This pass consists of drawing the incidence of light by projecting the objects directly on top of the lightmap, rejecting the points found at a distance from D, which is less than or equal to mask21 or greater than mask22. In order to calculate the light and reject the points, the same projection as that used at points 2 and 3 will be used to read the values of the textures color21, mask21 and mask22. The end value of the color to be added to the lightmap is calculated by means of the diffused light formula:

L=C₁·max(0,N·D)
C1: color of the texture color21
N: normal of the point.
D: projection direction
L: end light to be added to the lightmap
(6) The scene is drawn from the viewpoint of the light and the complete lighting in the texture “color21” is calculated, rejecting the pixels with a distance not equal to that of “mask22”.
(7) The texture mask21 is substituted by mask22 and point iii) is returned to.
iv) The new lightmaps are added to those of the previous pass, multiplying the lightmap by Kⁿ, where K is the bounce percentage and n is the bounce number:
v) The new lightmaps are used. If more bounce levels are to be calculated, point ii) is returned to

One of the advantages of this method is that the complexity of the calculation is linear as regards the number of bounces, unlike other systems based on ray tracing. In addition, the option to optimize speed by reducing the quality of the textures or the number of passes by half for each bounce also exists, which reduces the complexity of the algorithm to

$${\sum }_{i = 0}^{n} \frac{1}{{4}^{n}}$$

without drastically affecting the visual quality of the result.

Another advantage is that, since the scene itself emits light, the materials may be configured to emit light, thereby making it possible to calculate lights directly, using the geometrical shape, without increasing the process time of the scene. In other words, in the same amount of calculation time, it is possible to make a realistic approximation of the global illumination across the entire scene.

Given that the texture is accumulated and the passes are independent from one another, an iterative process is established, which carries out a lighting pass in each repetition. Furthermore, since the scene has already been optimized in order to be drawn in real time, it is possible to make one or more repetitions per second, which makes it possible to carry out the entire process in a few seconds, depending on the number of maps. Each time a lightmap has finished being calculated or after a certain number of passes, the scene is drawn with current lightmaps. As with all the calculations made in the GPU, it is possible to use any lightmap being calculated in the drawing of the scene almost instantly. The progress of the scene may therefore be shown, without impacting the light calculation process too greatly. In order to show the ambient lightmap mid process, the map must be shown by multiplying its value by π/n, where n is the number of repetitions made up to that moment.

In order to speed up the first user feedback, all of the maps are firstly calculated at a resolution two or more times lower, in order to accelerate rendering time and therefore end the process sooner. Once low quality has been calculated and shown, the process is continued at standard quality.

Since the passes are independent from one another, it is possible to distribute the calculation across various devices, computers or servers in a simple way. When a secondary computer connects to the main computer, the same selects a set of steps and sends them to the secondary computer. Once the same has loaded the scene, it calculates the lighting passes and sends the accumulation of passes to the main computer. The main computer receives the cumulated texture and in turn, accumulates it to the map being calculated. It then selects another block of passes and sends it to the secondary computer, continuing to do so successively. Since the passes are sent in packages, it is possible to connect new secondary computers to the main computer at any time during the process and the same will then receive new packages. Since this system also works in browsers on most personal computers, the browser itself may be used to connect to the main computer, in order to create a well-distributed lightmap calculation network, without having to install anything.

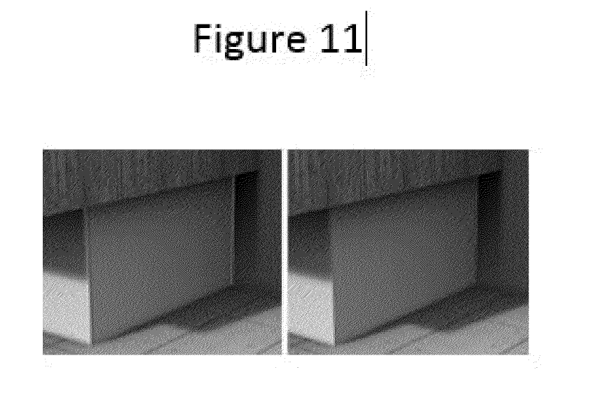

Since this process is based on shadow mapping, it suffers from the classical problems associated with this technique, namely that the quality of the result depends on the resolution of the shadow map, which is usually a maximum of 4K for a standard GPU. In order to exceed this limit, each lighting pass is divided into four sectors and a new lighting pass is assigned to each of the same, modifying their projection matrix such that it adjusts to the position of each sector. Since the sectors do not overlap, the new passes may be calculated and accumulated independently. This makes it possible to double the resolution of the original lightmap. This division may also be applied to each new lighting pass, in order to multiply the maximum resolution by 2̂n, where n is the maximum number of subdivisions. Since these new passes are processed independently, they are entered into the calculation queue, thus preserving the interactivity of the process despite increasing the number of repetitions needed and thereby, the time needed for it to come to an end (FIG. 11).

The number of subdivisions needed for a lighting pass may be optimized by calculating the difference in depth between the pixels of the shadow map of the pass. If there are no great differences between pixels, this means changes have not been produced by geometrical edges and that new subdivisions will not therefore improve the end quality. These variations may be calculated directly using a shader in the GPU in order to determine which areas have variations and which do not, thereby optimizing the number of passes needed.

Another improvement in the quality of the shadows consists in duplicating each lighting pass in order to obtain N passes with a slight modification between them in the coordinates at the center of the camera, the same being accumulated by multiplying the intensity by 1/N. Given that the shadow map is a discrete estimation of the geometry of the scene, the slight modifications will create small modifications at the edges of the geometries projected. Upon multiplying each pass by 1/N, the result will be equivalent to taking the average of the error, which will result in the edges of the shadows being smoother.

One of the problems with pre-calculating the lighting using lightmaps is maps of normals, since the lightmaps are pre-calculated including the normal of the surface of the triangle in the calculation and therefore, whilst drawing on screen using lightmaps, it makes no sense to include the map of normals in order to calculate the light, given that the same has already been pre-calculated. A simple method for mixing normal maps with pre-calculated lightmaps is presented. For each direct or ambient lightmap, 4 new lightmaps with half the resolution are calculated. These maps are calculated in the same way, however, rather than using the normal of the service, a direction inclined in one of the four directions, namely upwards, downwards, left and right is used (these directions constituting the four directions of a system with two coordinates). In order to draw the geometry, the four maps are interpolated according to the map of normals and the average is taken using the original lightmap. The end value is therefore the same as the initial values, which saves on errors, however, in turn makes it possible to show the differences in the surface, by means of using normal maps. The value of each one of the four directions will be relative to the normal of the surface of the triangle, not taking the maps of normals into account. The directions will therefore always be relative to the normal of the surface.

It is possible to amplify the number of directions by creating a new lightmap for each relative direction, in order to improve end quality, in addition to increasing or decreasing the resolution of these additional lightmaps.

It is possible to extend the method for generating a lightmap for each additional direction, in order to pre-calculate the specular light and reflected light, saving it in specular lightmaps which may subsequently be used to improve the quality of the rendering and of the diffused lightmaps.

In order to do so, one extra step is added to all of the processes described above, which consists in generating an additional lightmap per direction and saving the specular and reflected light therein at each point, according to the characteristics of the material. Each material has a function S, which makes it possible to calculate the amount of light reflected R at a given point, the normal N of the surface, the direction of the light L and the direction of the viewpoint V.

Furthermore, some materials have a perfect reflection component, such as mirrors, the function M of which makes it possible to calculate the amount of light perfectly reflected given the normal N, the direction of the other surface reflected L and the direction of the viewpoint V (FIG. 2).

Therefore, in order to calculate the specular component at a point, towards a direction, the amount of light reflected by both lights and perfect reflections must be added. In other words, for each direction D with a lightmap, the total specular value would be:

$$L S = {\sum }_{i = 0}^{n} {C}_{i} \cdot S ( D , N , {L}_{i} ) + {\sum }_{i = 0}^{m} {P}_{i} \cdot M ( D , N , {I}_{i} )$$

LS: specular lightmap

Cᵢ: color of the light i

S: specular calculation function

D: direction of the lightmap

N: normal of the surface

Lᵢ: direction of the light i

M: reflection function

Pᵢ: color of the reflected surface

Iᵢ: direction of incidence of the light of the reflected surface

The specular lightmaps are to be calculated following the same process as the normal (diffuse) lightmaps, but substituting the diffuse formula with this specular formula described above. In order to optimize the process, the calculation of the specular lightmaps need only be added to the lightmap calculation processes described above.

Once the specular lightmaps have been calculated, to obtain the specular value at a point from direction V:

$$S = {\sum }_{i = 0}^{n} {L}_{i} \cdot max ( 0 , V \cdot {D}_{i} ) / {\sum }_{i = 0}^{n} max ( 0 , V \cdot {D}_{i} )$$

Lᵢ: the color of this point on the specular lightmap i

V: the direction of the viewpoint

Dᵢ: the direction of the specular lightmap i

When objects with specular lightmaps are drawn on screen, the specular coefficient may be calculated using the above formula, and adding it to the render lighting function to get a higher-quality result. Moreover, the normal map may be used to modify the calculation of the specular component, which would add detail to the drawn surface.

To improve the result of the lightmap calculation for both direct and bounce, the specular lightmaps are added to the process. For each step in which the diffuse light is drawn by direct addition onto the lightmaps, another step is added in which the specular light is drawn directly into the specular lightmaps.

The difference between these two steps resides merely in the target lightmap and the light calculation formula, but both steps use exactly the same information and textures. In addition to this new step, the specular coefficient must be added in to the calculation of the lighting projected from one surface onto another. In this case, when the lighting of a pixel is being calculated in order to project it, calculating the result in the texture “color21”, the calculation is modified by adding the specular coefficient to it. Therefore, when the scene is drawn from the viewpoint of the light to calculate the projected light, in the texture “color21”, the complete illumination at the point is calculated by adding the diffuse and specular component.

The specular lightmaps may also be added to the calculation process of translucent objects that are improved by means of several passes instead of one single pass in multiplication mode. As has been explained, the specular lightmap calculation pass must be added to the process, and the specular component must be added when the texture “color22” is calculated.

A modification to the presented lightmap calculation will make it possible to calculate high-quality static images and renders. Once the lightmaps of the scene have been calculated, two textures are to be created, one which will contain the diffuse light and the other which will contain the specular light. Both textures will have the dimensions of the image that one wishes to render, such that for each pixel on screen there will be a corresponding diffuse and specular coefficient. To calculate the values of these two textures, the lightmap calculation method described above will be used, but with modifications to the way in which the lighting passes are calculated. The lighting passes are modified so that instead of accumulating the light using the UV coordinates of the objects, the objects are projected using the viewpoint of the camera, on top of one of the two textures, depending on the type of coefficient that one wants to calculate. Therefore, each lighting pass will be projected onto one of the two textures as if it were a lightmap. In these calculations the normal map of each geometry is used if it is available, in order to calculate the normal direction of the surface. Once the two textures have been calculated, the final image is generated, drawing the objects again on screen. However, for each pixel, the diffuse and specular value previously calculated in the textures is used.

This calculation is to be extended for translucent objects, using the process described above for calculating lightmaps including translucent objects.

The calculation of the static images must be carried out after having calculated all of the lightmaps of the scene including all of the bounces, making it so that the light bounces do not have to be calculated since they are already contained in the lightmaps of the scene. Therefore once the lightmaps of the scene have been calculated, the calculation of a high-quality static image entails a comparatively much smaller calculation process. In scenes where the objects' lighting and position do not vary, images can be calculated from different perspectives without having to generate the lightmaps of the whole scene over again, and therefore video frames can be calculated with minimal calculation time.

When calculating the lightmaps, the space between areas shows up as empty since it does not belong to any part of the object. When drawing the object, in the neighboring areas of the lightmaps these empty pixels mix together with the filled pixels. A common solution is to fill in the empty pixels using the nearest non-empty pixel, i.e. the areas are expanded. This approach improves the final result of the drawing, but in some situations it is insufficient since these pixels have not been calculated correctly. The solution to this problem is based on the idea of texture wrapping, but using the information of the triangles.

Given an island of triangles, one takes an edge of the perimeter belonging to two islands, and therefore belonging to two triangles. Since these two triangles have been separated, the chosen edge will have on the one side filled pixels belonging to one of the triangles, and on the other empty pixels. The proposed solution consists of filling in the empty pixels close to a triangle using the filled pixels of the other triangle and vice versa, which will create continuity in the texture by eliminating the empty areas. For each empty pixel, the nearest edge will be calculated, it will be determined whether there is another triangle that shares this edge at another point on the map, and the coordinates of that other triangle will be used to calculate what the corresponding pixel of the lightmap that would be if the two triangles had not been separated.

The invention of this application also includes automatic simplification of the curved surfaces of the geometry, maintaining visual detail. The angle-based UV coordinate calculation system is used again to divide the geometry into contiguous areas. To divide up the areas a low angle value is used, for example 5°, in order to obtain islands with a similar angle. Each island is reproduced by triangulating its perimeter, which will minimize the number of triangles in the island and reject internal triangles. Maintaining the original perimeter and just reducing the internal triangles ensures that the general shape of the geometry will be maintained and that only the curved areas will be simplified through flattening. In order to be able to draw the geometry while preserving the original detail, a normal map will be created onto which the normals of the original triangles are projected. In this way, when the simplified islands are drawn, the drawing will contain the curvature of the original triangles.

Since the angle of difference between triangles of each island is low and the perimeter is still maintained, the final drawing is very similar to the original one, with a fraction of the number of polygons. Once the coordinate map of the geometry has been calculated, the islands are retriangulated, the normal map is created, and in it the normals of the original islands are drawn, but using the positions of the new ordered islands. This process may be carried out using the GPU to obtain an almost immediate process.

Apart from the normal map, the displacement map is also calculated, as well as the UV coordinates of the diffuse texture channel. This information will make it possible to improve the quality of the rendering using a shader that accounts for the displacement map (cf. Chapter 8 of the book GPU Gems 2: “Per-Pixel Displacement Mapping with Distance Functions”, written by William Donnelly (University of Waterloo)), available without increasing the number of vertices. The displacement map can also be used during the lightmap calculation process to calculate internal occlusion. Lastly, the UV map can be used to improve the problems in the UV coordinates since the geometry has been simplified.

Given an island, its optimization may be improved by simplifying the number of faces of its perimeter using the following algorithm:
i) Two consecutive edges are selected (i.e. three vertices) of the island whose angle with the straight line is less than or equal to the simplification threshold angle, normally a low angle (for example 5°).
ii) If the two edges belong to the perimeter of another island, the two edges join into one in both islands, so that a small fragment switches islands. If not, they are rejected.
iii) Return to point i) until there are no more pairs of edges that are unprocessed or meet the requirements for joining.
iv) Once all of the edges have been processed, a perimeter will be obtained wherein the difference between edges between two contiguous islands is greater than or equal to the minimum angle, which will reduce the number of faces without significantly affecting the perceived form.
v) The perimeter will be triangulated in order to obtain the final result of the fully optimized island.

The angle with the straight line would be the supplementary angle on the inside, in the case of convex islands, or the supplementary angle on the outside, in the case of concave islands. It is worth noting that this same algorithm optimizes both a concave and a convex island.

Presented is an algorithm that enables the loading of textures and images to the memory of the device to be adjusted. The algorithm is based on progressively lowering the quality parameters of the textures until the sum of all the textures and the geometries is less than the limit of the device:
i) The images are classified depending on their function: texture, normal map, lightmap, cube maps and UI (user interface) images.
ii) The memory size of each type is calculated: Mt, Mn, Ml, Mc, Mui. The size of a texture is obtained by multiplying its width and height by the bytes per pixel (normally 4), and normally by the increment due to the use of mipmaps (1.33). When the quality of a type of texture is reduced, the dimensions of all of its textures are divided by 2, giving a 4× reduction of memory:

$$M = \frac{T x \cdot T y \cdot 4 \cdot 1.33}{{4}^{Q}}$$

M: memory of a texture T

Q: texture quality, where 0 is maximum quality

(*) bear in mind that UI images can have a maximum quality of 1 to preserve the minimum quality of elements containing text.
iii) The memory size of the geometry is calculated. The size of the geometry is obtained by adding up the indexes of the triangles and the vertices. The size of the vertices depends on the attributes it contains: position, normal, UV1 coordinates, UV2 coordinates, binormal, etc. If the use of a certain type of textures is deactivated, some of these attributes may be ignored, which makes it possible to save memory.
iv) The total memory size of the textures and the geometry without reducing any quality is calculated, and if it is not less than the memory limit the algorithm continues.
v) The quality of one of the 4 factors in a unit is reduces, always in the same order: Mn, Mt, Ml, Mc, Mui.
vi) The total memory is calculated, accounting for the quality factors of each type. If the memory is less than the limit, the algorithm ends. Otherwise, it returns to point v)
vii) When the quality factor has already been reduced by 3, one type of texture quality is deactivated following the same order as before, and the remaining qualities are calculated again from 0, bearing in mind that since one type of texture has been deactivated, the geometry does not need to use all of the attributes, giving more memory space for the textures.
viii) If after applying the algorithm the qualities cannot be calculated, then there is not enough memory to load the scene.

Once the list of qualities has been obtained, the scene is loaded using these qualities. In order to do so, versions of all the possible image qualities must have been generated beforehand. In other words, for each image, it saves the original version, the version at 50%, at 25%, and so on up to the maximum quality reduction number. When loading the model, the textures are chosen based on the quality of their type.

1- A rendering method characterized in that it comprises defining islands of connected triangles whose difference between normals is less than the geometries of the instances, and putting them in boxes, and in that said boxes are in turn grouped into cubes by material and textures, prior to calculating the lightmaps.

2- The rendering method according to claim 1, comprising dividing the lightmap into three different textures: direct lights, ambient illumination or occlusion and sunlight, and calculating them independently.

3- The rendering method according to the preceding claim, comprising iteratively calculating the lightmaps and showing the result to the user at each stage.

4- The rendering method according to claim 1, wherein the arrangement of the boxes inside the cube begins with the largest ones, placing them a previously calculated distance apart from one another on each axis.

5- The rendering method according to the preceding claim, wherein the distance between boxes is previously calculated by dividing the largest dimension of the total boxes by the square root of the number of the largest boxes, preferably higher than the 25th percentile, and multiplying by the percentage of space one desires to leave free.

6- The rendering method according to the preceding claim, which places the boxes in the cube with the following stages:
[a]. placing the first box with a vertex at the origin of coordinates of the cube;
[b]. selecting the next box in size and placing it at the free vertex that is nearest to the origin of coordinates, such that the increase in size of the cube is minimal or nil;
[c]. repeating stage [b] with all of the largest boxes;
[d]. selecting the next box in size and placing it at the free vertex that is nearest to the origin of coordinates;
[e]. repeating stage [d] with all of the remaining boxes.

7- The rendering method according to the preceding claim, which normalizes the boxes, for each box storing just the nearest coordinate and the farthest coordinate from the reference point in the cube.

8- The rendering method according to claim 1, comprising the optimization of the boxes, recursively dividing the islands when the quality or ratio of the area of the island over the area of the box is less than a percentage.

9- The rendering method according to the preceding claim, wherein the recursive division is based on making a programmable number of imaginary axes distributed homogeneously at an angle and which pass through the center of the box, and for each one separating the polygons fully contained on one side of the imaginary axis into a first new island, and the rest into a second new island and calculating the quality of their respective boxes, and selecting the imaginary axis that results in the greatest total quality for the resulting boxes.

10- The rendering method according to claim 1, wherein the vertices have a texture attribute.

11- The rendering method according to claim 1, wherein the vertices have an attribute formed by an index to a list of transformation matrices.

12- The rendering method according to claim 1, comprising an island optimization process that selects groups of three consecutive vertices that are common to two islands and whose angle with the straight line is less than a low angle, preferably 5°, eliminates the middle vertex, retriangulates the islands and generates a new normal map, projecting the normals of the complex islands onto the optimized ones.

13- The rendering method according to claim 1, which distributes the geometries with the same material and texture in cubes with a limit or maximum number of vertices.

14- The method according to the preceding claim, comprising the stages of:
[a]. ordering the geometries with the same material and texture, from more vertices to less;
[b]. creating a first cube and adding the first geometry to it;
[c]. selecting the next geometry;
[d]. passing over the cubes in order until finding one in which the total number of vertices will not exceed the limit if the geometry is added;
[e]. if no free cube is found, creating a new cube and adding the geometry to it;
[f]. repeating for the rest of the geometries.

15- The rendering method according to claim 1, which calculates the necessary number of lightmaps as one per each set of material and texture plus one lightmap per each material and texture of each dynamic node.

16- The rendering method according to claim 1, which recursively groups the animated nodes with their non-animated child nodes by material and texture, creating one unique lightmap per group.

17- A rendering method characterized in that it comprises defining islands of connected triangles whose difference between normals is less than the geometries of the instances, and putting them in normalized boxes that are in turn grouped into cubes, prior to calculating the lightmaps, and in that each box is only defined by the nearest coordinate and the farthest coordinate from the reference point in the cube.

18- The rendering method according to the preceding claim, wherein the boxes are grouped into cubes by their material and texture.

19- The rendering method according to claim 18, which recursively groups the animated nodes with their non-animated child nodes by material and texture, creating one unique lightmap per group.

20- The rendering method according to the preceding claim, which distributes the instances with the same material and texture in cubes with a limit or maximum number of vertices.

21- The method according to the preceding claim, comprising the stages of:
[a]. ordering the instances with the same material and texture, from more vertices to less;
[b]. creating a first cube and adding the first instances to it;
[c]. selecting the next instances;
[d]. passing over the cubes in order until finding one in which the total number of vertices will not exceed the limit if the instances are added;
[e]. if no free cube is found, create a new cube and add the instances to it;
[f]. repeating for the rest of the instances.

22- The rendering method according to claim 17, comprising dividing the lightmap into three different textures: direct lights, ambient illumination or occlusion and sunlight, and calculating them independently.

23- The rendering method according to claim 17, wherein the arrangement of the boxes inside the cube begins with the largest ones, placing them a previously calculated distance apart from one another on each axis.

24- The rendering method according to the preceding claim, wherein the distance between boxes is previously calculated by dividing the largest dimension of the total boxes by the square root of the number of the largest boxes, preferably higher than the 25th percentile, and multiplying by the percentage of space one desires to leave free.

25- The rendering method according to the preceding claim, which places the boxes in the cube with the following stages:
[a]. placing the first box with a vertex at the origin of coordinates of the cube;
[b]. selecting the next box in size and placing it at the free vertex that is nearest to the origin of coordinates, such that the increase in size of the cube is minimal or nil;
[c]. repeating stage [b] with all of the largest boxes;
[d]. selecting the next box in size and placing it at the free vertex that is nearest to the origin of coordinates;
[e]. repeating stage [d] with all of the remaining boxes.

26- The rendering method according to claim 17, comprising the optimization of the boxes, recursively dividing the islands when the quality or ratio of the area of the island over the area of the box is less than a percentage.

27- The rendering method according to the preceding claim, wherein the recursive division is based on making a programmable number of imaginary axes distributed homogeneously at an angle and which pass through the center of the box, and for each one separating the polygons fully contained on one side of the imaginary axis into a first new island, and the rest into a second new island and calculating the quality of their respective boxes, and selecting the imaginary axis that results in the greatest total quality for the resulting boxes.

28- The rendering method according to claim 17, comprising an island optimization process that selects groups of three consecutive vertices that are common to two islands and whose angle with the straight line is less than a low angle, preferably 5°, eliminates the middle vertex, retriangulates the islands and generates a new normal map, projecting the normals of the complex islands onto the optimized ones.

29- A lightmap calculation method in a rendering process, comprising dividing the lightmap into three different textures: direct lights, ambient illumination or occlusion and sunlight, and calculating them independently.

30- The method according to the preceding claim, which calculates the textures of sunlight and direct lights through the stages of:
i) creating a texture with per-pixel values;
ii) splitting each light into different simpler passes defined by a point of origin and a direction;
iii) accumulating the lighting passes.

31- The method according to the preceding claim, which calculates the texture of ambient light through the stages of:
i) simulating the light from the sky as a set of directional lights that illuminate the entire scene from all directions taking the color of the sky in that direction to simulate the color of the directional light;
ii) calculating the ambient illumination of a point as:
$$L = \frac{π}{n} {\sum }_{i = 0}^{n} C i \cdot max ( 0 , N \cdot D i )$$
where L is the ambient light at a point, N is the normal of the point, Di is the direction of the ray of light and Ci is the color of the sky in this direction;
iii) The sky is divided in N equidistant directions and for each one a directional lighting pass is created that is situated at the center of the model and which encompasses the entire model;
iv) All of the passes accumulate in the texture and lastly the result is multiplied by π/n.

32- The method according to the claim 30, which calculates the texture of ambient occlusion through the stages of:
i) simulating the light from the sky as a set of directional lights that illuminate the entire scene from all directions, assigning the color white to the sky;
ii) calculating the ambient illumination of a point as:
$$L = \frac{π}{n} {\sum }_{i = 0}^{n} C i \cdot max ( 0 , N \cdot D i )$$
where L is the ambient light at a point, N is the normal of the point, Di is the direction of the ray of light and Ci is the color white of the sky;
iii) The sky is divided in N equidistant directions and for each one a directional lighting pass is created that is situated at the center of the model and which encompasses the entire model;
All of the passes accumulate in the texture and lastly the result is multiplied by π/n.

33- The method according to the preceding claim, which calculates the texture after passing through translucent materials by means of approximating the calculation of the amount of light by multiplying the color of the light by the color of the objects, accounting for their opacity:
$$L = L c \cdot {\prod }_{k = 1}^{n} ( 1 - {A}_{k} ) + {A}_{k} {C}_{k}$$
where L is the light that reaches the point, Aₖ is the coefficient of alpha that defines the opacity of the object, Cₖ is the color of the object that will filter the light, and L_{c} is the color of the light;
and where the translucent objects are initially treated as opaque in order to calculate the incident light and a new lighting pass is carried out on the translucent objects using the z-buffer of the previous render.

34- The method according to the preceding claim, which calculates the light that reaches each translucent object with the stages of:
i) creating the texture where the color of the light filtered through the translucent objects will be calculated, which will be referred to as “color11”, initializing it to white;
ii) creating the texture “depth_end” wherein the depth map of the opaque objects will be rendered from the viewpoint of the light;
iii) creating a texture to reject the surfaces for which the ray has already been calculated, which will be referred to as “mask11”, and will be initialized with the minimum depth value;
iv) creating the texture “mask12” wherein the depth map of the translucent objects is rendered from the viewpoint of the light, and drawing them as opaque, rejecting the pixels that have a distance less than or equal to “mask11”;
v) rendering the translucent objects again in a separate texture, “color 12”, rejecting the pixels whose distance is not equal to mask 12;
vi) drawing the texture “color12” on top of the texture “color11”, multiplying it;
vii) rendering the translucent objects in the lightmap by multiplying the calculated lighting in the lightmap of the pixel by the color of the texture color11, using the same UV coordinate that is used to project the 3D point in the shadow map, and rejecting all the pixels whose distance is not equal to mask2;
viii) if the value of all of the pixels of mask12 is not equal to “depth_end”, substitute the texture mask11 with the texture mask12 and repeat from point iv).

35- The method according to the preceding claim, which calculates the indirect light through the following stages:
i) calculating the lightmaps of the scene with the indirect light;
ii) generating a copy of the lightmaps and initializing it to 0;
iii) dividing the space in N directions and calculating all the rays that bounce in each direction, and accumulating them in the lightmaps;
iv) adding the new lightmaps to those of the prior pass, multiplying the lightmap by Kⁿ, where K is the bounce percentage and n is the bounce number:
v) returning to point ii) for each desired bounce level.

36- The method according to the preceding claim, which calculates all the rays that bounce or are emitted in each direction, and accumulates them in the lightmaps through the stages of:
(1) creating a texture, “mask21” to reject the surfaces for which the ray has already been calculated, and initializing it with the minimum depth value;
(2) creating another texture “color21” that will contain the light to be projected from one surface onto another and initializing it with the color black;
(3) drawing the scene from the point of view of the light, rejecting those whose real depth is less than mask21, and calculating the depth in a new texture, mask22, initialized beforehand with the maximum depth value;
(4) ending the pass if all of the pixels in mask22 have the maximum depth value;
(5) performing a lighting pass calculating the incidence of the light projected on the rest of the surfaces using the diffuse light calculation and adding it in to the lightmap;
(6) drawing the scene from the viewpoint of the light and calculating the complete lighting in the texture “color21”, rejecting the pixels whose distance is not that of “mask22”;
(7) substituting the texture mask21 with mask22 and returning to point (3).

37- The method according to claim 31, wherein each lighting pass is divided into sectors.

38- The method according to claim 31, wherein each lighting pass is divided into several passes with an equivalent total intensity.

39- The rendering method according to the preceding claim, comprising iteratively calculating the lightmaps and showing the result to the user at each stage.

40- The method according to claim 36, which calculates four new lightmaps using, for each triangle, a direction deviated from the normal in four or more directions derived from a two-coordinate system.

41- The method according to claim 36, which generates an additional lightmap for the specular and reflected light at each point by means of the formula:
$$L S = {\sum }_{i = 0}^{n} {C}_{i} \cdot S ( D , N , {L}_{i} ) + {\sum }_{i = 0}^{m} {P}_{i} \cdot M ( D , N , {I}_{i} )$$
where LS is the specular lightmap; Cᵢ is the color of the light i; S in the function of the specular calculation, D is the direction of the lightmap; N is the normal of the surface; Lᵢ is the direction of the light i; M is the reflection function; Pᵢ is the color of the reflected surface and Iᵢ is the direction of incidence of the light of the reflected surface; and substituting the diffuse formula with this specular formula described herein; and wherein one obtains the specular value at a point from direction V:
$$S = {\sum }_{i = 0}^{n} {L}_{i} \cdot max ( 0 , V \cdot {D}_{i} ) / {\sum }_{i = 0}^{n} max ( 0 , V \cdot {D}_{i} )$$
where Lᵢ is the color of this point on the specular lightmap i; V is the direction of the viewpoint and Dᵢ is the direction of the specular lightmap i.

42- The method according to claim 29, which calculates the lightmap of the pixels that are contiguous to the perimeter of an island, calculating the nearest edge and finding out whether there is another triangle that shares this edge at another point of the cube, and using the coordinates of that other triangle to calculate the pixel of the lightmap.

43- The method according to claim 41 which carries out rendering of static images, once the lightmaps of the light of the scene have been calculated, creating the diffuse light and specular light textures with the dimensions of the image to be rendered, accumulating the lighting passes using the viewpoint of the camera, on top of the corresponding texture and drawing the objects again on screen using, for each pixel, the calculated diffuse and specular value.

44- The rendering method according to claim 31, wherein the calculation of lighting passes is distributed between several devices.

45- The rendering method according to claim 29, which calculates the size of each lightmap in pixels by means of the formula:
$$R i = D \cdot \frac{S i}{\frac{1}{n} \cdot {\sum }_{i = 0}^{n} Sn}$$
where Ri is the resolution of the lightmap i; Si is the size of the UV coordinates map i; Sn is the size of the UV coordinates map n; and D is the dimensions of the texture by default.

46- The rendering method according to claim 29, which calculates the resolution of each lightmap according to the formula:
F=max(1,P/D)
where P is the minimum number of pixels of separation between boxes defined by the user; F is the multiplication factor of the lightmap resolution and D is the pixels of separation between boxes, with which the lightmap was calculated.

47- A rendering method characterized in that it adjusts the loading of textures and images to the memory of the device through the stages of:
i) classifying the images depending on their function: texture, normal map, lightmap, cube maps and user interface;
ii) calculating the memory size of each type: Mt, Mn, Ml, Mc, Mui;
iii) calculating the memory size of the geometry;
iv) if the total memory size of the textures and the geometry is less than or equal to the memory of the device, end the method;
v) reducing the quality of all the images of one type in one unit;
vi) if the total memory is still greater than the memory of the device, return to point v) with the following type of images, always in the same order: Mn, Mt, Ml, Mc, Mui, up to a maximum of three times per type;
vii) if the total memory is still greater than the memory of the device, deactivate one type of images in the indicated order and restore the quality of the rest, repeating steps v) and vi) with the other textures.

48- The rendering method according to the preceding claim, which for each image saves the original version and all of the versions up to the maximum quality reduction number.
